(19) United States
(12) Patent Application Publication
(10) Pub. No.: US 2010/0053965 A1
(43) Pub. Date: Mar. 4, 2010

(54) LED LAMP

(75) Inventors: CHING-KUN CHANG, Taipei (TW); CHENG-HSIUNG KUO, Jhonghe City (TW); YEN-FU LIU, Tucheng City (TW)

Correspondence Address: PAI PATENT & TRADEMARK LAW FIRM, 1001 FOURTH AVENUE, SUITE 3200, SEATTLE, WA, 98154, US

(73) Assignee: ENERGYLED CORPORATION, SINDIAN CITY (TW)

(21) Appl. No.: 12/511,927

(22) Filed: Jul. 29, 2009

(30) Foreign Application Priority Data
Sep. 1, 2008 (TW) 097215699

(51) Int. Cl. F21S 4/00

(52) U.S. Cl. 362/249.02

(57) ABSTRACT

A LED lamp comprises: a lamp base; an illuminating component, mounted on the lamp base, wherein the illuminating component comprises a circuit board and a plurality of LEDs arranged on the circuit board; a lamp shade, mounted on the lamp shade for enclosing the illuminating element, wherein the lamp shade has at least one open area; and at least one waterproof and ventilative element, disposed on the open area for covering the open area; thereby, vapors inside the lamp shade can vacate out of the LED lamp through the waterproof and ventilative element, while external vapors cannot infiltrate into the lamp shade through the waterproof and ventilative element.

### BACKGROUND OF THE INVENTION

1. Field of the Invention

The present invention relates to a LED (light emitting diode) lamp, and more particularly to a LED lamp which provides perfect illumination.

2. Description of Related Art

LEDs are light emitting devices constructed by semiconductor materials. Compared to conventional non-LED illuminating devices, they are superior because of high illuminating efficiency, long lifetime and good durability. Therefore, LEDs have been widely applied to lamps or other electronics such as LED displays and electronic watches.

In order to provide enough light for illumination, a plurality of LEDs is arranged together on a circuit board. Referring to FIG. 1, a conventional LED light includes a lamp base 1a, a lamp shade 2a, a circuit board 3a and a plurality of LEDs 4a.

The lamp shade 2a is a transparent hollow tube shielding the lamp base 1a. The circuit board 3a is inside the lamp shade 2a with the LEDs 4a on the circuit board 3a. Thereby, a conventional LED light is accomplished with a predetermined illuminating effect.

However, when the conventional LED lamp is at a condition of high humidity or in a raining weather, water molecules will enter from any unconcealed edges between the lamp base 1a and the lamp shade 2a. Water molecules are then evaporated by the heat which is generated by the illumination of the LEDs 4a. The obtained vapors condense on an interior of the lamp shade 2a to become water drops 5a that may block the path of light illumination. The illuminating effect will be obviously deteriorated.

Therefore, there is a need of a novel invention that overcomes the above disadvantages.

### SUMMARY OF THE INVENTION

It is one object of the present invention to provide a LED lamp which can vacate vapors out, prevent vapors from infiltrating, and further prevent condensation of vapors when at condition of high humidity or in raining environment, so that significantly improved illuminating and aesthetic effect can be offered.

In order to achieve the above and other objectives, a LED lamp according to the invention comprises: a lamp base; an illuminating component, mounted on the lamp base, wherein the illuminating component comprises a circuit board and a plurality of LEDs arranged on the circuit board; a lamp shade, mounted on the lamp shade for enclosing the illuminating element, wherein the lamp shade has at least one open area; and at least one waterproof and ventilative element, disposed on the open area; thereby, vapors inside the lamp shade can vacate out of the LED lamp through the waterproof and ventilative element, and external vapors fail to infiltrate into the lamp shade through the waterproof and ventilative element.

The efficacy of the present invention is as follows. The arrangement of the waterproof and ventilative element over the open area of the lamp shade contributes to the vacation of vapors out of the LED light by the heat generated from the illumination of LEDs, when the LED light is at very humid or raining condition. On the other hand, external vapors cannot infiltrate into the lamp shade through the waterproof and ventilative element. It is evidenced that LED lamp according to the invention has significantly improved illuminating and aesthetic effect.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a schematic view showing vapors condense on an interior of a conventional LED lamp.

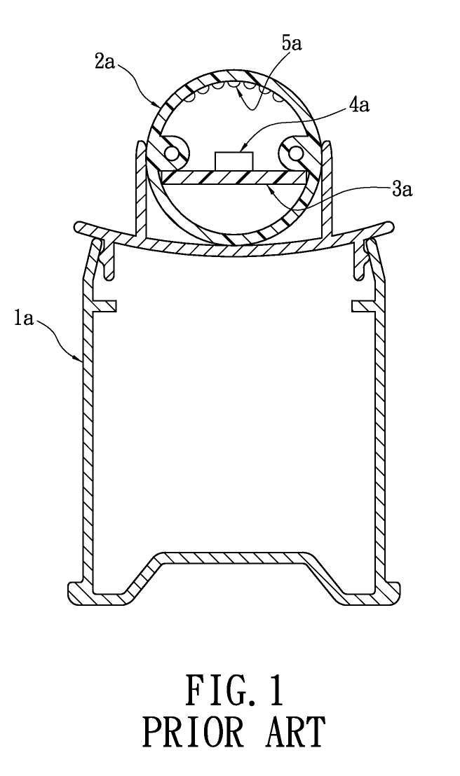

FIG. 2 is an exploded view of a LED lamp according to the invention.

FIG. 3 is perspective view of a LED lamp according to one embodiment of the invention.

FIG. 4 is a cross-sectional view of a LED lamp according to the invention.

FIG. 5 is perspective view of a LED lamp according to another embodiment of the invention.

### DETAILED DESCRIPTION OF THE PREFERRED EMBODIMENTS

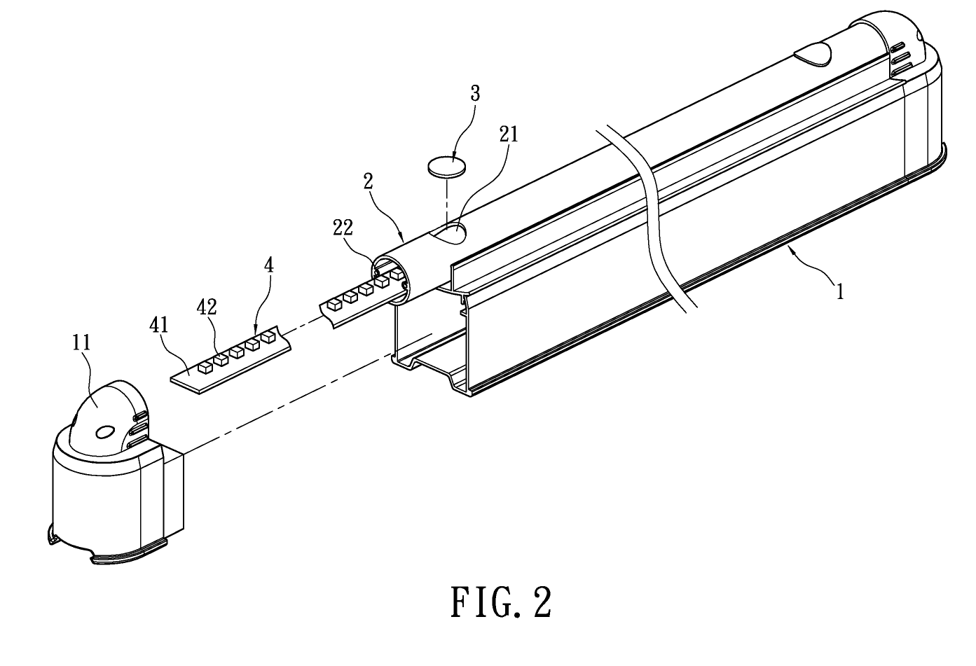

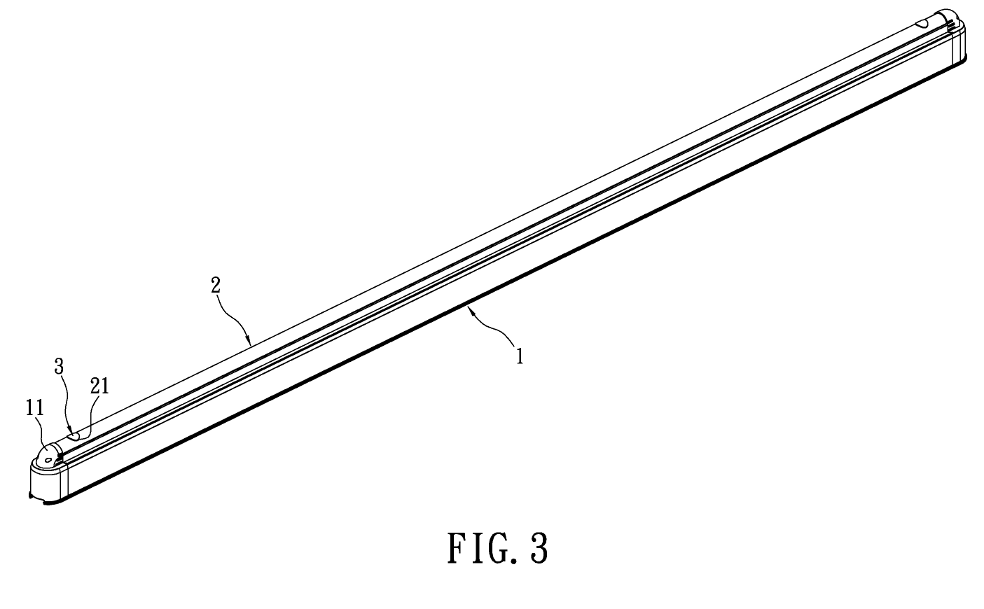

Referring to FIG. 2 through FIG. 4, a light emitting diode (LED) lamp according to the invention comprises: a lamp base 1, a lamp shade 2, a plurality of waterproof and ventilative elements 3 and an illuminating component 4.

The lamp base 1 has a rectangular frame being integrally made of metal, such as aluminum. The lamp base 1 is mounted with two electrically conductive sockets 11; the two electrically conductive sockets 11 are respectively located at opposite terminals of the lamp base 1. The two electrically conductive sockets 11 are electrically connected so as to provide power needed for a LED 42 to emit light.

The lamp shade 2 is a hollow tube; two opposite ends of the lamp shade 2 are respectively connected to the two electrically conductive sockets 11. The lamp shade 2 is integrally made of polymer which provides the lamp shade 2 with transparency. The lamp shade 2 has two open areas 21. The open areas 21 can be through holes oppositely on the lamp shade 2. The open areas 21 also can be circular hole just through the whole wall of the lamp shade 2.

The lamp shade 2 has two fixtures 22 which are in shape of strip extended from an inner wall of the lamp shade 2. A lower part of each fixture 22 attaches to an upper edge of a circuit board 41, while a lower edge of the circuit board 41 attaches to the inner wall of the lamp shade 2. Thereby, the circuit board 41 can be securely mounted inside the lamp shade 2.

In one of the embodiment of the invention, the LED lamp has two the waterproof and ventilative elements 3. Those waterproof and ventilative elements 3 are made of waterproof and ventilative fabrics and have circular shapes corresponding to the open areas 21 so as to be able to be sealed over the open areas 21. The material for the waterproof and ventilative elements 3 is polytetrafluoethylene (PTFE) foam which has properties of waterproof and ventilation. Because the waterproof and ventilative elements 3 own properties of having perfectly meticulous and intensive pores, i.e. perfect porosity, the waterproof and ventilative elements 3 are able to block any water drops from infiltrating while allows vapors to vacate out.

The illuminating component 4 is mounted on the lamp base 1. The illuminating component 4 has a plurality of LEDs 42 and the circuit board 41.

The circuit board 41 is transversely disposed in the interior of the lamp shade 2 and electrically connected to two electrically conductive sockets 11. The LEDs 42 serially arranged on the circuit board 41 so that the LEDs 42 can be offered the power needed for illumination. The illuminating component 4 is enclosed in the lamp shade 2, which increases lifetime of the illuminating component 4.

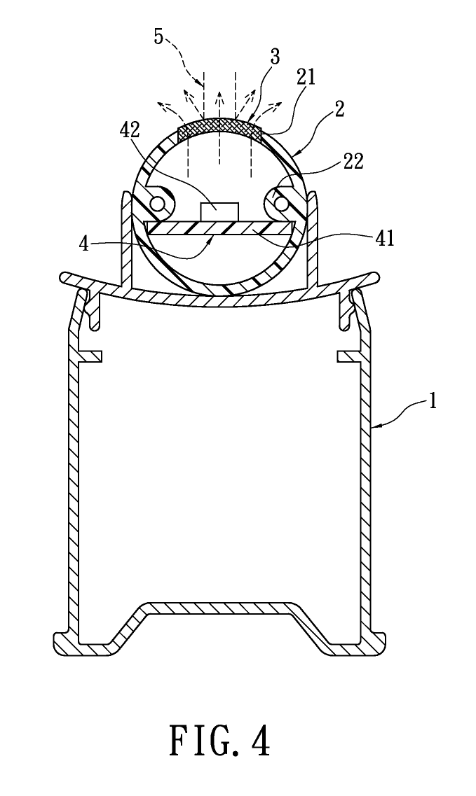

Referring to FIG. 4, when external environment is very humid or in raining, vapors 5 can infiltrate through any edges of the LED lamp easily. However, the illumination of the LEDs 42 generates heat. Heat will make vapors 5 vacate out of the LED lamp through the waterproof and ventilative elements 3, and prevent water drops from entering the LED lamp as well. Therefore, the interior of the lamp shade 2 can be kept dry. The problem of deteriorating the illuminating performance due to the condensation of vapors on the inner wall of the lamp shade 2 will not occur.

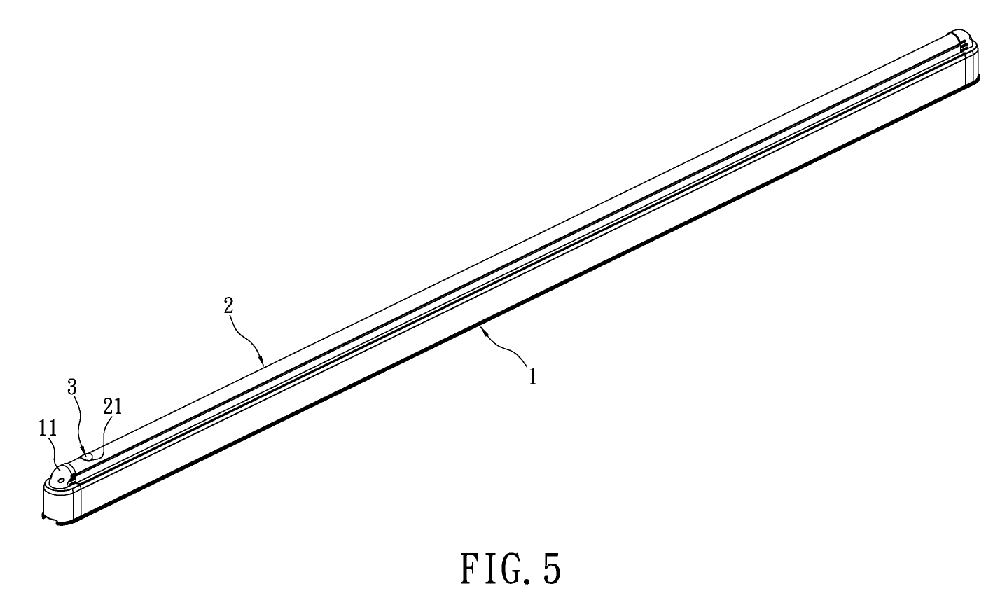

Referring to FIG. 5, which is another embodiment of the invention. In this embodiment, the lamp shade 2 has an open area 21 and a waterproof and ventilative element 3 corresponding to the open area 21. Similarly, the configuration can achieve as the same effect as the previous embodiment. It is noted that the number of the open area 21 and the waterproof and ventilative element 3 is not limited to those illustrated here. Users can determine their number and location as long as the LEDs can achieve the equal vapor vacating effect. In other words, any equivalents in which the lamp shade 2 has at least one open area 21 for enclosing the waterproof and ventilative element 3 is regarded as in the scope of the invention.

The invention can offer the following advantages.

The arrangement of the waterproof and ventilative element 3 over the open area 21 of the lamp shade 2 contributes to the vacation of vapors 5 out of the LED light by the heat generated from the LEDs 42, when the LED light is at very humid or raining condition. On the other hand, external vapors 5 will not infiltrate into the lamp shade 2 through the waterproof and ventilative element 3. It is believed that LED lamp according to the invention has significantly improved illuminating and aesthetic effect.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A LED lamp, comprising:
a lamp base;
an illuminating component, mounted on the lamp base, wherein the illuminating component comprises a circuit board and a plurality of LEDs arranged on the circuit board;
a lamp shade, mounted on the lamp base and enclosing the illuminating element, wherein the lamp shade has an open area; and
a waterproof and ventilative element, disposed on the open area for covering the open area;
thereby, vapors inside the lamp shade vacate out of the LED lamp through the waterproof and ventilative element, external vapors fail to infiltrate into the lamp shade through the waterproof and ventilative element.

2. The LED lamp of claim 1, wherein the lamp base has two electrically conductive sockets respectively at two opposite terminals of the lamp base, the lamp shade is a hollow tube, two opposite ends of the lamp shade are respectively connected to the two electrically conductive sockets, and the circuit board of the illuminating component is electrically connected to the two electrically conductive sockets.

3. The LED lamp of claim 1, wherein the lamp shade has two fixtures being extended from an inner wall of the lamp shade, and the circuit board being attached to the two fixtures and the interior of the lamp shade.

4. The LED lamp of claim 1, wherein the waterproof and ventilative element is made of waterproof and ventilative fabric.

5. The LED lamp of claim 4, wherein the waterproof and ventilative element is made of polytetrafluoethylene foam.

6. The LED lamp of claim 1, wherein the open area is a through hole.

7. A LED lamp, comprising:
a lamp base;
an illuminating component, mounted on the lamp base, wherein the illuminating component comprises a circuit board and a plurality of LEDs arranged on the circuit board;
a lamp shade, mounted on the lamp base and enclosing the illuminating element, wherein the lamp shade has a plurality of open areas; and
a plurality of waterproof and ventilative elements, respectively disposed on the open areas for covering those open areas;
thereby, vapors inside the lamp shade vacate out of the LED lamp through the waterproof and ventilative elements, external vapors fail to infiltrate into the lamp shade through the waterproof and ventilative elements.

8. The LED lamp of claim 7, wherein the lamp base has two electrically conductive sockets respectively at two opposite terminals of the lamp base, the lamp shade is a hollow tube, two opposite ends of the lamp shade are respectively connected to the two electrically conductive sockets, and the circuit board of the illuminating component is electrically connected to the two electrically conductive sockets.

9. The LED lamp of claim 7, wherein the lamp shade has two fixtures being extended from an inner wall of the lamp shade, and the circuit board being attached to the two fixtures and the interior wall of the lamp shade.

10. The LED lamp of claim 7, wherein the waterproof and ventilative elements are made of waterproof ventilative fabric.

11. The LED lamp of claim 10, wherein the waterproof and ventilative elements are made of polytetrafluoethylene foam.

12. The LED lamp of claim 7, wherein the open areas are through holes.
